(19) United States
(12) Patent Application Publication
(10) Pub. No.: US 2021/0143730 A1
(43) Pub. Date: May 13, 2021

(54) ACTIVE CLAMP SNUBBER FOR FLYBACK POWER CONVERTER

(71) Applicant: Richtek Technology Corporation, Zhubei City (TW)

(72) Inventors: Ta-Yung Yang, Taoyuan (TW); Kwan-Jen Chu, Hsinchu (TW)

(21) Appl. No.: 17/075,576

(22) Filed: Oct. 20, 2020

Related U.S. Application Data
(60) Provisional application No. 62/933,917, filed on Nov. 11, 2019.

(30) Foreign Application Priority Data
May 13, 2020 (TW) 109115894

(51) Int. Cl. H02M 1/34; H02M 3/335

(52) U.S. Cl. CPC H02M 1/34; H02M 2001/0009; H02M 2001/344; H02M 3/33523

(57) ABSTRACT

A flyback power converter includes: a transformer, a primary side switch, a snubber capacitor and an active clamp snubber. The snubber capacitor is charged by a leakage inductance current of a primary winding fora snubber period following after a time point when the primary side switch is turned OFF. The active clamp snubber includes a snubber control switch which is connected in series to the snubber capacitor. The series circuit of the snubber control switch and the snubber capacitor is connected in parallel to the primary winding. The leakage inductance current charges the snubber capacitor through the snubber control switch during the snubber period. The snubber capacitor provides a capacitor voltage as electrical power of the active clamp snubber. A voltage level of a reference node between the snubber control switch and the snubber capacitor serves as a snubber ground level of the active clamp snubber.

### CROSS REFERENCE

The present invention claims priority to U.S. 62/933,917 filed on Nov. 11, 2019 and claims priority to TW 109115894 filed on May 13, 2020.

### BACKGROUND OF THE INVENTION

### Field of Invention

The present invention relates to a flyback power converter; particularly, it relates to such flyback power converter having a snubber capacitor. The present invention also relates to an active clamp snubber of such flyback power converter.

### Description of Related Art

Please refer to FIG. 1, which shows a schematic diagram of a conventional flyback power converter (i.e., flyback power converter 1). The flyback power converter 1 is configured to operably convert an input power to an output power. The flyback power converter 1 comprises: a transformer 10, a snubber circuit 20, a primary side control circuit 30 and a primary side switch S1. The snubber circuit 20 has a snubber capacitor Cs, a snubber resistor Rs and a snubber diode Dsnb, which together form a passive snubber that is passively turned ON when the primary side switch S1 is turned OFF, so that energy stored in a leakage inductance Lr of a primary winding W1 during a period when the primary side switch S1 is turned ON can be stored in the snubber capacitor Cs and consumed by the snubber resistor Rs, thereby preventing the pulse voltage generated when the primary side switch S1 is switching from being too high to damage the circuit devices.

As shown in FIG. 1, the primary side control circuit 30 is configured to operably control the primary side switch S1, so as to switch the primary winding W1 of the transformer 10, thus converting the input power to the output power, that is, a secondary winding W2 of the transformer 10 will generate the output power at an output node OUT. The input power includes an input voltage Vin and an input current Iin, whereas, the output power includes an output voltage Vout and an output current Iout. When the primary side switch S1 is turned ON, electrical energy is stored in the primary winding W1; when the primary side switch S1 is turned OFF, the electrical energy stored in the primary winding W1 is transferred from the primary winding W1 to the secondary winding W2, so as to generate the output power at the output node OUT. Furthermore, when the primary side switch S1 is switched from ON to OFF, a leakage inductance current Ir flows through the snubber diode Dsnb to charge the snubber capacitor Cs, and the snubber resistor Rs will consume excess energy. The passive snubber formed by the snubber capacitor Cs, the snubber resistor Rs and the snubber diode Dsnb receives the leakage inductance current Ir, so as to prevent the pulse voltage generated when the primary side switch S1 is switching from being too high to damage the circuit devices. The power Prs consumed by the snubber resistor Rs can be represented by following equation:

Prs=[(n*Vout)²/Rs]+(0.5*Lr*Ip²*Freq)

wherein Prs denotes the power consumed by the snubber resistor Rs, n denotes a turn ratio of the primary winding W1 to the secondary winding W2, Ip denotes a primary side switching current, more specifically a peak value of a primary side current (i.e., a current flowing through the primary winding W1), and Freq denotes a switching frequency of the primary side switch S1.

The prior art shown in FIG. 1 has the following drawbacks that: under a situation where the switching frequency of the primary side switch S1 is high, and/or under a situation where the level of the output voltage Vout is high, the power Prs consumed by the snubber resistor Rs is too high, which causes unwanted power loss and undesirably reduces the power conversion efficiency.

In view of the above, to overcome the drawbacks in the prior art, the present invention proposes a flyback power converter and an active clamp snubber of a flyback power converter, which can reduce power consumed by a snubber capacitor when a snubber capacitor is employed, thereby improving power conversion efficiency.

### SUMMARY OF THE INVENTION

From one perspective, the present invention provides a flyback power converter, comprising: a transformer including: a primary winding coupled to an input power; and a secondary winding coupled to an output node; a primary side switch coupled to the primary winding, the primary side switch being configured to operably switch the primary winding, so as to convert the input power, thereby causing the secondary winding to generate an output power at the output node; a snubber capacitor, which is configured to be operably charged by a leakage inductance current of the primary winding for a snubber period which follows after a time point when the primary side switch is turned OFF; and an active clamp snubber, which includes a snubber control switch, wherein the snubber control switch is connected in series to the snubber capacitor, and wherein the primary winding is connected in parallel to a series circuit formed by the snubber control switch and the snubber capacitor, wherein the leakage inductance current charges the snubber capacitor through the snubber control switch during the snubber period; wherein a capacitor voltage across the snubber capacitor provides an electrical power to the active clamp snubber, and wherein a voltage level of a reference node between the snubber control switch and the snubber capacitor serves as a snubber ground level of the active clamp snubber.

In one embodiment, the active clamp snubber further includes: a power regulation circuit, which is configured to operably convert the capacitor voltage to a snubber power regulation voltage which is supplied to the active clamp snubber as the electrical power; and a control signal generation circuit coupled to the power regulation circuit and the snubber control switch, the control signal generation circuit being configured to operably sense a time point when the primary side switch is turned from ON to OFF, and to operably generate a snubber control signal for turning ON the snubber control switch.

In one embodiment, the active clamp snubber further includes: an overcharging protection circuit including a first comparison circuit, wherein the first comparison circuit is configured to operably generate an overcharging comparison signal when the capacitor voltage exceeds a first predetermined voltage threshold, so as to electrically connect the snubber capacitor to a bleeder current path in the overcharging protection circuit, so that the capacitor voltage is controlled not exceeding the first predetermined voltage threshold.

In one embodiment, the active clamp snubber further includes: a bypass diode, which is connected in parallel to the snubber control switch; wherein the control signal generation circuit is configured to operably sense a bypass current flowing through the bypass diode, so as to confirm the time point when the primary side switch is turned from ON to OFF, for turning ON the snubber control switch to charge the snubber capacitor by the leakage inductance current.

In one embodiment, the control signal generation circuit includes: a second comparison circuit coupled to the bypass diode, wherein the second comparison circuit is configured to operably generate a determination result when a voltage level of a detection end of the bypass diode does not exceed a second predetermined voltage threshold, the ON determination result indicating that the bypass current is flowing through the bypass diode; and a first determination circuit coupled to the second comparison circuit, wherein the first determination circuit is configured to operably generate the snubber control signal according to the determination result for turning ON the snubber control switch when the bypass current is sensed.

In one embodiment, the control signal generation circuit further includes: a third comparison circuit coupled to the bypass diode, wherein the third comparison circuit is configured to operably generate an OFF determination result when the voltage level of the detection end of the bypass diode exceeds a third predetermined voltage threshold, wherein the generated OFF determination result is inputted to the first determination circuit, wherein the first determination circuit is configured to operably generate the snubber control signal according to the OFF determination result for turning OFF the snubber control switch.

In one embodiment, the control signal generation circuit further includes: a fourth comparison circuit, which is configured to operably generate an under voltage lockout (UVLO) determination result when the capacitor voltage is lower than a fourth predetermined voltage threshold, wherein the first determination circuit is configured to operably generate the snubber control signal according to the UVLO determination result for turning OFF the snubber control switch.

In one embodiment, the control signal generation circuit further includes: a first timer circuit, which is configured to operably start counting a volt-second balance period at a time point when the snubber control switch is turned ON, wherein after the volt-second balance period ends, the first timer circuit is configured to operably generate a volt-second timing signal; and a second determination circuit, which is configured to operably cause the first determination circuit to turn OFF the snubber control switch according to the volt-second timing signal after the volt-second balance period ends.

In one embodiment, the active clamp snubber further includes: a second timer circuit, which is configured to operably start counting a maximum ON period at a time point when the snubber control switch is turned ON, whereby the snubber control switch is turned OFF after the maximum ON period ends.

In one embodiment, the overcharging protection circuit further includes: an overcharging switch, which is configured to operably determine to cause the snubber capacitor to be electrically connected to the bleeder current path in the overcharging protection circuit according to the overcharging comparison signal when the capacitor voltage exceeds the first predetermined voltage threshold; and an overcharging current source coupled to the snubber capacitor and the overcharging switch, wherein the overcharging current source is configured to operably generate a bleeder current on the bleeder current path, so as to prevent the capacitor voltage from exceeding the first predetermined voltage threshold.

In one embodiment, with reference to the snubber ground level, the first predetermined voltage threshold is correlated with a product of an output voltage of the output power multiplied by a turn ratio of the primary winding to the secondary winding.

In one embodiment, the active clamp snubber further includes: a current sensing circuit having a current sensing transistor and a current sensing resistor, wherein the current sensing transistor is connected in series to the current sensing resistor, and wherein the snubber control switch is connected in parallel to a series circuit formed by the current sensing transistor and the current sensing resistor; wherein the control signal generation circuit includes: a fifth comparison circuit coupled to the current sensing resistor, wherein the fifth comparison circuit is configured to operably generate a determination result according to a voltage drop across the current sensing resistor and a fifth predetermined voltage threshold; and a third determination circuit coupled to the fifth comparison circuit, wherein the third determination circuit is configured to operably generate the snubber control signal according to the determination result for turning ON the snubber control switch.

In one embodiment, the control signal generation circuit further includes: a sixth comparison circuit coupled to the current sensing resistor, wherein the sixth comparison circuit is configured to operably generate an OFF determination result according to the voltage drop across the current sensing resistor and a sixth predetermined voltage threshold; wherein the third determination circuit is further configured to operably generate the snubber control signal according to the OFF determination result for turning OFF the snubber control switch.

In one embodiment, the control signal generation circuit further includes: a third timer circuit, which is configured to operably start counting a maximum ON period at a time point when the snubber control switch is turned ON, whereby the snubber control switch is turned OFF after the maximum ON period ends, and the third timer circuit ceases counting according to the OFF determination result.

In one embodiment, the control signal generation circuit further includes: a fourth timer circuit, which is configured to operably start counting a volt-second balance period at a time point when the snubber control switch is turned ON, so that the snubber control switch is turned OFF after the volt-second balance period ends.

From another perspective, the present invention provides an active clamp snubber, which is configured to operably control a leakage inductance current of a primary winding of a flyback power converter to charge a snubber capacitor for a snubber period which follows after a time point when the primary side switch is turned OFF; the active clamp snubber comprising: a snubber control switch, which is connected in series to the snubber capacitor, and wherein the primary winding is connected in parallel to a series circuit formed by the snubber control switch and the snubber capacitor, wherein the leakage inductance current charges the snubber capacitor through the snubber control switch during the snubber period; a power regulation circuit, which is configured to operably convert the capacitor voltage to a snubber power regulation voltage, wherein the snubber power regulation voltage is configured to operably supply an electrical power to the active clamp snubber; and a control signal generation circuit coupled to the power regulation circuit and the snubber control switch, the control signal generation circuit being configured to operably sense a time point when the primary side switch is turned from ON to OFF, and accordingly to operably generate a snubber control signal for turning ON the snubber control switch; wherein a voltage level of a reference node between the snubber control switch and the snubber capacitor serves as a snubber ground level of the active clamp snubber.

From yet another perspective, the present invention provides an overcharging protection circuit, which is configured to operably control an active clamp snubber, wherein the active clamp snubber is configured to operably control a leakage inductance current of a primary winding of a flyback power converter to charge a snubber capacitor for a snubber period which follows after a time point when the primary side switch is turned OFF; the active clamp snubber including: a snubber control switch, which is connected in series to the snubber capacitor, and wherein the primary winding is connected in parallel to a series circuit formed by the snubber control switch and the snubber capacitor, wherein the leakage inductance current charges the snubber capacitor through the snubber control switch during the snubber period; a power regulation circuit, which is configured to operably convert the capacitor voltage to a snubber power regulation voltage, wherein the snubber power regulation voltage is configured to operably supply an electrical power to the active clamp snubber; and a control signal generation circuit coupled to the power regulation circuit and the snubber control switch, the control signal generation circuit being configured to operably sense a time point when the primary side switch is turned from ON to OFF, and accordingly to operably generate a snubber control signal for turning ON the snubber control switch; wherein a voltage level of a reference node between the snubber control switch and the snubber capacitor serves as a snubber ground level of the active clamp snubber; wherein the overcharging protection circuit comprises: a bleeder current path coupled to the snubber capacitor; and a first comparison circuit, which is configured to operably generate an overcharging comparison signal when the capacitor voltage exceeds a first predetermined voltage threshold, so as to electrically connect the snubber capacitor to the bleeder current path, so that a bleeder current is generated from the snubber capacitor, whereby the capacitor voltage is control not exceeding the first predetermined voltage threshold.

In one embodiment, the overcharging protection circuit further comprises: an overcharging switch, which is configured to operably electrically connect the snubber capacitor to the bleeder current path in the overcharging protection circuit according to the overcharging comparison signal when the capacitor voltage exceeds the first predetermined voltage threshold; and an overcharging current source coupled to the snubber capacitor and the overcharging switch, wherein the overcharging current source is configured to operably supply the bleeder current to the bleeder current path, so as to control the capacitor voltage not exceeding the first predetermined voltage threshold; wherein the overcharging switch and the overcharging current source form the bleeder current path.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a conventional flyback power converter.

FIG. 2A shows a schematic diagram of a flyback power converter according to an embodiment of the present invention.

FIG. 2B illustrates waveforms depicting the operation of a primary side switch control signal and a snubber control signal according to an embodiment of the present invention

FIG. 3 shows an embodiment of an active clamp snubber.

FIG. 4 shows an embodiment of a control signal generation circuit.

FIG. 5 shows another embodiment of an active clamp snubber.

FIG. 6 shows another embodiment of a control signal generation circuit.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

Please refer to FIG. 2A, which shows a schematic diagram of a flyback power converter (i.e., flyback power converter 3) according to an embodiment of the present invention. The flyback power converter 3 of the present invention comprises: a transformer 10, a primary side switch S1, a snubber capacitor Cs, a primary side control circuit 30 and an active clamp snubber 50. As shown in FIG. 2A, the transformer 10 includes a primary winding W1 and a secondary winding W2. The primary winding W1 is coupled to an input power. The input power includes an input voltage Vin (with reference to a primary side ground level GNDpri) and an input current Iin. The secondary winding W2 is coupled to an output node OUT. The primary side switch S1 is coupled to the primary winding W1 and is configured to operably switch the primary winding W1, thereby causing the secondary winding W2 to generate an output power at the output node OUT. The output power at the output node OUT is supplied to a load circuit 40. The output power includes an output voltage Vout (with reference to a ground level GND) and an output current Iout.

The primary winding W1 has a leakage inductance Lr (as shown by a dashed symbol indicative of an inductor in FIG. 2A). As one of average skill in the art readily understands, “leakage inductance” is generated in a transformer which is in an incomplete coupling state. In a non-ideal transformer, the coupling coefficient between the primary winding and the secondary winding is smaller than one; under such circumstance, a part of a winding of such actual non-ideal transformer does not operate for power transformation. Accordingly, this part of winding is referred to as “leakage inductance”. On the other hand, in an ideal transformer, the primary winding and the secondary winding of such ideal transformer are in a complete coupling state (i.e., the coupling coefficient between the primary winding and the secondary winding is equal to one). That is, in an ideal transformer, the leakage inductance is equal to zero. However, such ideal transformer does not exist; so, in an actual circuit, a leakage inductance exists and this is well known to those skilled in the art.

Please refer to FIG. 2A in conjugation with FIG. 2B. FIG. 2B illustrates waveforms depicting the operation of a primary side switch control signal S1C and a snubber control signal S2C according to an embodiment of the present invention. During a snubber period Tsnb (as shown in FIG. 2B) which follows after a time point when the primary side switch S1 is turned OFF, a snubber control switch S2 of the active clamp snubber 50 is turned ON according to a snubber control signal S2C generated in the active clamp snubber 50, so that a leakage inductance current Ir of the primary winding W1 charges the snubber capacitor Cs. Thus, electrical energy stored in the leakage inductance Lr when the primary side switch S1 is turned ON is delivered to the snubber capacitor Cs. Besides, this prevents the pulse voltage generated when the primary side switch S1 is switching from being too high to damage the circuit devices.

The active clamp snubber 50 includes a snubber control switch S2. The snubber control switch S2 is connected in series to the snubber capacitor Cs. The primary winding W1 is connected in parallel to the series circuit of the snubber control switch S2 and the snubber capacitor Cs. The leakage inductance current Ir charges the snubber capacitor Cs through the snubber control switch S2 during the snubber period Tsnb. The snubber capacitor Cs supplies a capacitor voltage Vc (with reference to a snubber ground level GNDsnb) as an electrical power to the active clamp snubber 50. In addition, a voltage level of a reference node REF between the snubber control switch S2 and the snubber capacitor Cs is the snubber ground level GNDsnb of the active clamp snubber 50.

In one embodiment, the active clamp snubber 50 further includes: a bypass diode, which is connected in parallel to the snubber control switch S2. When a bypass current flowing through the bypass diode is sensed, the active clamp snubber 50 adjusts the snubber control signal S2C to turn ON the snubber control switch S2, to charge the snubber capacitor Cs by the leakage inductance current Ir.

In one embodiment, in the active clamp snubber 50 shown in FIG. 2A, a parasitic diode Dp (as shown by a dashed symbol indicative of a diode in FIG. 2A) of the snubber control switch S2 can be adopted to function as the above-mentioned bypass diode. The parasitic diode Dp is connected in parallel to the snubber control switch S2. After the primary side switch Si has been switched from ON to OFF and before the snubber control switch S2 is turned ON, because the voltage at the anode end (which is the reference node REF) of the parasitic diode Dp is higher than the voltage at the cathode end (which is coupled to the input voltage Vin) of the parasitic diode Dp, the parasitic diode Dp is turned ON to generate a bypass current Idp which flows through the parasitic diode Dp (under such circumstance, the bypass current Idp is equal to the leakage inductance current Ir). Therefore, this embodiment can sense whether a bypass current Idp is flowing through the parasitic diode Dp by sensing a change of the voltage drop across two ends of the parasitic diode Dp, so as to confirm the time point when the primary side switch S1 is turned from ON to OFF. A control signal generation circuit 502 (referring to FIG. 3) of the active clamp snubber 50 senses the bypass current Idp flowing through the bypass diode to confirm the time point when the primary side switch S1 is turned from ON to OFF, and turns ON the snubber control switch S2 accordingly to charge the snubber capacitor Cs by the leakage inductance current Ir.

In one embodiment, the active clamp snubber 50 can control the snubber control signal S2C to turn OFF the snubber control switch S2 when the leakage inductance current Ir is not sensed. In such embodiment, that the leakage inductance current Ir is not sensed indicates that the electrical energy stored in the leakage inductance Lr during the period wherein the primary side switch S1 is turned ON has been completely stored in the snubber capacitor Cs or is unable to charge the snubber capacitor Cs anymore. Accordingly, turning OFF the snubber control switch S2 when the leakage inductance current Ir is not sensed can prevent the ON period of the snubber control switch S2 from being too long, which may undesirably result in a large circulation current, leading to undesirable power loss. In other words, as shown in FIG. 2B, in one embodiment, the ON period of the snubber control switch S2 coincides with a period in which the leakage inductance current Ir is greater than zero (as shown by the snubber period Tsnb in FIG. 2B).

According to the present invention, in one embodiment, at the time point when the primary side switch S1 is turned from ON to OFF, the voltage level at the phase node PHASE between the primary side switch S1 and the snubber capacitor Cs is input voltage Vin plus n-fold (n denotes turn ratio) of output voltage Vout, with reference to the primary side ground level GNDpri. The active clamp snubber 50 can charge the snubber capacitor Cs with this high voltage. Besides, the capacitor voltage Vc across the snubber capacitor Cs provides the required electrical power to the active clamp snubber 50.

Please refer to FIG. 3, which shows an embodiment of an active clamp snubber. As shown in FIG. 3, the active clamp snubber 50 includes: a snubber control switch S2, a power regulation circuit 501, a control signal generation circuit 502, an overcharging protection circuit 503 and a voltage-divider circuit 504. The power regulation circuit 501 is configured to operably convert the capacitor voltage Vc to a snubber power regulation voltage Vcc, to supply electrical power to other circuits in the active clamp snubber 50. The power regulation circuit 501 can be, for example but not limited to, a low dropout linear regulator (LDO) and/or a charge pump, which can be selected by those skilled in the art depending upon practical needs. In one embodiment, the power regulation circuit 501 can be omitted. Under such situation where the power regulation circuit 501 is omitted, all circuits in the active clamp snubber 50 can directly retrieve power from the capacitor voltage Vc.

As shown in FIG. 3, the control signal generation circuit 502 is coupled to the power regulation circuit 501 and the snubber control switch S2. The control signal generation circuit 502 is configured to operably generate the snubber control signal S2C when the bypass current Idp is sensed, so as to turn ON the snubber control switch S2. As shown in FIG. 3, the control signal generation circuit 502 has a detection end Vind. In one embodiment, the detection end Vind for example can be electrically connected to an anode end of a detection diode Dd, whereas, a cathode end of the detection diode Dd can be electrically connected to the input voltage Vin and a current output end DTC of a parasitic diode Dp. When the bypass current Idp flows through the parasitic diode Dp, the voltage level of the current output end DTC (with reference to the snubber ground level GNDsnb) will be lower than a second predetermined voltage threshold Vth2, which indicates that the bypass current Idp has flowed through the parasitic diode Dp. Under such situation, the control signal generation circuit 502 will adjust the snubber control signal S2C to turn ON the snubber control switch S2, such that the snubber capacitor Cs is charged by the leakage inductance current Ir.

On the other hand, when the snubber control switch S2 is turned ON, when a voltage level (with reference to the snubber ground level GNDsnb) of the detection end Vind does not exceed a predetermined voltage threshold Vth3 (indicating that leakage inductance current Ir is near zero or equal to zero), the control signal generation circuit 502 will adjust the snubber control signal S2C to turn OFF the snubber control switch S2, such that the snubber capacitor Cs is stopped from being charged by the leakage inductance current Ir. Besides, the control signal generation circuit 502 can perform an under voltage lockout (UVLO) procedure further according to a divided voltage Vcb of the capacitor voltage Vc. For example, when the divided voltage Vcb does not exceed a predetermined voltage threshold Vth4, it indicates that the capacitor voltage Vc of the snubber capacitor Cs is too low to supply power to the active clamp snubber 50. Under such situation, this embodiment can turn OFF the snubber control switch S2 before the control signal generation circuit 502 fails to operate, to cease charging the snubber capacitor Cs via the leakage inductance current Ir. From another perspective, when a voltage level (with reference to the snubber ground level GNDsnb) of the detection end Vind does not exceed a predetermined voltage threshold Vth3, it indicates that the leakage inductance current Ir is near zero or equal to zero; on the other hand, when a voltage level (with reference to the snubber ground level GNDsnb) of the current output end DTC is lower than the second predetermined voltage threshold Vth2, it indicates that the leakage inductance current Ir is greater than zero.

As shown in FIG. 3, when a divided voltage Vca related to the capacitor voltage Vc exceeds a predetermined voltage threshold Vth1, the overcharging protection circuit 503 is configured to operably electrically connect the snubber capacitor Cs to a bleeder current path in the overcharging protection circuit 503, so that the capacitor voltage Vc does not exceed a first predetermined voltage threshold. The overcharging protection circuit 503 for example includes a first comparison circuit 5031, an overcharging switch S3 and an overcharging current source 5033. As shown in FIG. 3, the first comparison circuit 5031 is configured to operably compare the divided voltage Vca related to the capacitor voltage Vc with the predetermined voltage threshold Vth1, so as to generate an overcharging comparison signal OCC. The overcharging switch S3 is controlled for example by the overcharging comparison signal OCC. When the overcharging comparison signal OCC indicates that the divided voltage Vca exceeds the predetermined voltage threshold Vth1, it indicates that the capacitor voltage Vc exceeds the first predetermined voltage threshold. Under such circumstance, the overcharging switch S3 is turned ON, so as to electrically connect the snubber capacitor Cs to the bleeder current path, thus preventing the capacitor voltage Vc from exceeding the first predetermined voltage threshold.

The bleeder current path can be formed by the overcharging switch S3 and the overcharging current source 5033 which are connected in series to each other between the capacitor voltage Vc and the snubber ground level GNDsnb. The overcharging current source 5033 is coupled to the snubber capacitor Cs and the overcharging switch S3, to generate a bleeder current through the bleeder current path, so that the capacitor voltage Vc is controlled not exceeding the first predetermined voltage threshold. In one embodiment, the first predetermined voltage threshold is with reference to the snubber ground level GNDsnb, and is correlated with a product of the output voltage Vout of the output power multiplied by a turn ratio n of the primary winding W1 to the secondary winding W2. That is, in one embodiment, the capacitor voltage Vc is controlled not to exceed: n*Vout.

Please refer to FIG. 4, which shows a specific embodiment of a control signal generation circuit. As shown in FIG. 4, the control signal generation circuit 502 includes: a second comparison circuit 5021, a determination circuit 5022, a third comparison circuit 5023, a fourth comparison circuit 5024, a determination circuit 5025 and a timer circuit 5026. The second comparison circuit 5021 is coupled to a bypass diode (i.e., the parasitic diode Dp shown in FIG. 3). The second comparison circuit 5021 is configured to operably generate an ON determination result according to the voltage level of the current output end DTC of the bypass diode and the second predetermined voltage threshold Vth2. As shown in FIG. 4, the second comparison circuit 5021 for example has a negative input end which is electrically connected to the detection end Vind. In this embodiment, the detection end Vind is electrically connected to an anode end of a detection diode Dd. A cathode end of the detection diode Dd is electrically connected to the input voltage Vin and the current output end DTC of the parasitic diode Dp. A positive input end of the second comparison circuit 5021 receives the predetermined voltage threshold Vth2.

More specifically, under a situation where the snubber control switch S2 is turned OFF, when the leakage inductance current Ir is greater than zero, the bypass current Idp will flow through the parasitic diode Dp (under such situation, the bypass current Idp is substantially equal to the leakage inductance current Ir), such that the voltage level of the detection end Vind (with reference to the snubber ground level GNDsnb) is lower than the predetermined voltage threshold Vth2, which indicates that the leakage inductance current Ir is greater than zero. That is, an ON determination result is generated when the voltage level of the detection end Vind does not exceed the predetermined voltage threshold Vth2, which indicates that the bypass current Idp flows through the parasitic diode Dp. As a consequence, the determination circuit 5022 will adjust the snubber control signal S2C to turn ON the snubber control switch S2, such that the snubber capacitor Cs is charged by the leakage inductance current Ir, thereby reducing power loss caused by the parasitic diode Dp.

As shown in FIG. 4, the determination circuit 5022 is coupled to the second comparison circuit 5021. The determination circuit 5022 is configured to operably generate the snubber control signal S2C according to the ON determination result, such that the snubber control signal S2C turns ON the snubber control switch S2 when the bypass current Idp is sensed. As shown in FIG. 4, the determination circuit 5022 can include, for example but not limited to, two flip-flops FF1 and FF2. An input pin D of the flip-flop FF1 receives a snubber power regulation voltage Vcc; a clock pin of the flip-flop FF1 is electrically connected to an output end of the second comparison circuit 5021, to receive the ON determination result; a reset pin R of the flip-flop FF1 is electrically connected to an output end of the third comparison circuit 5023, to receive the OFF determination result; an output pin Q of the flip-flop FF1 is electrically connected to a clock pin of the flip-flop FF2, so that the output pin Q of the flip-flop FF1 can output a determination result from the flip-flop FF1.

On the other hand, the third comparison circuit 5023 is coupled to a bypass diode (i.e., the parasitic diode Dp shown in FIG. 3). The third comparison circuit 5023 is configured to operably generate an OFF determination result according to a voltage level of the current output end DTC of the bypass diode and a third predetermined voltage threshold. As shown in FIG. 4, the third comparison circuit 5023 for example has a negative input end which is electrically connected to the detection end Vind. The detection end Vind for example is electrically connected to an anode end of the detection diode Dd. A cathode end of the detection diode Dd is electrically connected to the input voltage Vin and the current output end DTC of the parasitic diode Dp. A positive input end of the third comparison circuit 5023 receives the predetermined voltage threshold Vth3.

More specifically, when the snubber control switch S2 is turned ON (so that all the leakage inductance current Ir substantially flows through a conduction channel of the snubber control switch S2), when the leakage inductance current Ir drops to zero or near zero, a voltage level of the detection end Vind (with reference to the snubber ground level GNDsnb) rises. When the voltage level of the detection end Vind is higher than the third predetermined voltage threshold (i.e., when the voltage level of the detection end Vind exceeds the predetermined voltage threshold Vth3), an OFF determination result is accordingly generated, which indicates that the leakage inductance current Ir is near zero or equal to zero. As a consequence, the determination circuit 5022 will adjust the snubber control signal S2C to turn OFF the snubber control switch S2, so as to cease charging the snubber capacitor Cs by the leakage inductance current Ir.

Please still refer to FIG. 4. The fourth comparison circuit 5024 for example compares a divided voltage Vcb (as shown in FIG. 3 and FIG. 4) of the capacitor voltage Vc with a predetermined voltage threshold Vth4, so as to generate an under voltage lockout (UVLO) determination result when the capacitor voltage Vc is lower than a fourth predetermined voltage threshold. The generated UVLO determination result is inputted into the determination circuit 5025, whereby the determination circuit 5022 adjusts the snubber control signal S2C to turn OFF the snubber control switch S2. That is, in one embodiment, the fourth comparison circuit 5024 is configured to operably determine whether to execute an UVLO procedure.

Please still refer to FIG. 4. The determination circuit 5025 can be, for example but not limited to, a NOR gate logic circuit as shown in FIG. 4. When the divided voltage Vcb is not higher than the predetermined voltage threshold Vth4, it indicates that the capacitor voltage Vc is lower than the fourth predetermined voltage threshold. Under such circumstance, an output signal generated from the determination circuit 5025 resets the flip-flop FF2 of the determination circuit 5022, so that the determination circuit 5022 adjusts the snubber control signal S2C to turn OFF the snubber control switch S2. It should be understood that to embody the determination circuit 5025 as a NOR gate logic circuit in the above-mentioned embodiment is only an illustrative example. In other embodiments, it is also practicable and within the scope of the present invention that the determination circuit 5025 can be any other logic circuits or determination circuits providing equivalent or similar functions.

Please still refer to FIG. 4. The timer circuit 5026 is configured to start counting a volt-second balance period at a time point when the snubber control switch S2 is turned ON. After the volt-second balance period ends, the timer circuit 5026 generates a volt-second timing signal which is inputted into the determination circuit 5025, so that the determination circuit 5025 resets the flip-flop FF2 of the determination circuit 5022. Accordingly, the determination circuit 5022 adjusts the snubber control signal S2C to turn OFF the snubber control switch S2. It is noteworthy that, as one of average skill in the art readily understands, the term “volt-second balance” indicates that products of voltage multiplied by second at two ends of an inductor must be balanced with each other within a complete cycle period. In other words, in one embodiment, the above-mentioned volt-second balance period is correlated with, for example but not limited to, parameters such as the input voltage Vin, the output voltage Vout and the equivalent inductance of the transformer 10, which is well known to those skilled in the art, so the details thereof are not redundantly explained here.

In this embodiment, an input pin D of the flip-flop FF2 of the determination circuit 5022 receives a snubber power regulation voltage Vcc; a clock pin of the flip-flop FF2 is electrically connected to an output pin Q of the flip-flop FF1; a reset pin R of the flip-flop FF2 is electrically connected to an output end of the determination circuit 5025, so that the reset pin R of the flip-flop FF2 receives the output signal generated from the determination circuit 5025; an output pin Q of the flip-flop FF2 generates the snubber control signal S2C.

In this embodiment, the flip-flop FF1 and the flip-flop FF2 can determine the snubber control signal S2C according to the ON determination result, the OFF determination result, the UVLO determination result and the volt-second timing signal. It should be understood that the above-mentioned implementation using the flip-flop FF1 and the flip-flop FF2 to operate in combination in the above-mentioned embodiment is only an illustrative example. In other embodiments, it is also practicable and within the scope of the present invention that the above-mentioned efficacy can be achieved via different circuits and/or different coupling ways and operation mechanisms, which can be readily conceived by those skilled in this art according to the teachings disclosed in the present invention, so the details thereof are not redundantly explained here.

Please refer to FIG. 5, which shows another embodiment of an active clamp snubber. This embodiment of FIG. 5 is different from the embodiment of FIG. 3 in that: the active clamp snubber 50 in this embodiment further includes a current sensing circuit 505. The current sensing circuit 505 includes a current sensing transistor S4 and a current sensing resistor Rcs. The current sensing transistor S4 is connected in series to the current sensing resistor Rcs. The snubber control switch S2 is connected in parallel to the series circuit formed by the current sensing transistor S4 and the current sensing resistor Rcs. As shown in FIG. 5, both the current sensing transistor S4 and the snubber control switch S2 are controlled by the snubber control signal S2C. Under such configuration, a predetermined proportional relationship is established between a current Is4 flowing through the current sensing transistor S4 and a current Is2 flowing through the snubber control switch S2. That is, this embodiment can sense the current Is2 flowing through the snubber control switch S2 by means of sensing the current Is4 flowing through the current sensing transistor S4 . The current Is4 includes a bypass current Ic4 flowing through a channel of the current sensing transistor S4 and a parasitic current Ids flowing through a parasitic diode Ds. The current Is2 flowing through the snubber control switch S2 includes a bypass current Ic2 flowing through a channel of the snubber control switch S2 and a bypass current Idp. In this embodiment, the approach of sensing whether a bypass current Idp is flowing through the parasitic diode Dp by means of sensing a voltage change at a detection end Vind is omitted. Instead, this embodiment can sense whether there is a leakage inductance current Ir (i.e., whether the leakage inductance current Ir is greater than zero) by means of sensing a voltage change at a detection end Vcs, which is a result of a change of the voltage drop across the current sensing resistor Rcs caused by the current Is4 flowing through the current sensing transistor S4 (the current Is4 includes a bypass current Ic4 flowing through a channel of the current sensing transistor S4 and a parasitic current Ids flowing through a parasitic diode Ds). It should be understood that because this embodiment senses the leakage inductance current Ir by the above-mentioned approach, the control signal generation circuit 506 is different from the control signal generation circuit 502 of the previous embodiment shown in FIG. 4, which will be described in detail later.

Please refer to FIG. 6, which shows another embodiment of a control signal generation circuit. This embodiment shows a specific embodiment of the control signal generation circuit 506 of FIG. 5. As shown in FIG. 6, the control signal generation circuit 506 includes: a fifth comparison circuit 5061, a determination circuit 5062, a sixth comparison circuit 5063, a determination circuit 5064, a timer circuit 5065, a timer circuit 5066 and a determination circuit 5067.

As shown in FIG. 6, the fifth comparison circuit 5064 is coupled to the current sensing resistor Rcs and is configured to operably generate an ON determination result according to a voltage drop across the current sensing resistor Rcs (i.e., a voltage at a detection end Vcs) and a predetermined voltage threshold Vth5. The determination circuit 5062 is coupled to the fifth comparison circuit 5061 and is configured to operably generate the snubber control signal S2C according to the ON determination result, such that the snubber control signal S2C turns ON the snubber control switch S2. The sixth comparison circuit 5063 is coupled to the current sensing resistor Rcs and is configured to operably generate an OFF determination result (which indicates that the leakage inductance current Ir drops to zero or near zero) according to the voltage drop across the current sensing resistor (i.e., the voltage at the detection end Vcs) and a predetermined voltage threshold Vth6. Thus, the determination circuit 5062 can generate the snubber control signal S2C according to the OFF determination result, so as to turn OFF the snubber control switch S2.

Please still refer to FIG. 6. The timer circuit 5065 of the control signal generation circuit 506 is configured to start counting a maximum ON period at a time point when the snubber control switch S2 is turned ON, whereby the snubber control switch S2 is turned OFF after the maximum ON period ends, and the timer circuit 5065 ceases counting according to the OFF determination result. The timer circuit 5066 is configured to start counting a volt-second balance period at a time point when the snubber control switch S2 is turned ON, whereby the snubber control switch S2 is turned OFF after the volt-second balance period ends.

As shown in FIG. 6, the fifth comparison circuit 5061 includes a negative input end which is electrically connected to the detection end Vcs via a resistor. The detection end Vcs for example is electrically connected to the current sensing resistor Rcs. A positive input end of the fifth comparison circuit 5061 receives the predetermined voltage threshold Vth5.

More specifically, when both the current sensing transistor S4 and the snubber control switch S2 are turned OFF, when the leakage inductance current Ir rises (e.g., when the leakage inductance current Ir rises higher than zero), the bypass current Idp will flow through the parasitic diode Dp, while also the parasitic current Ids will flow through the parasitic diode Dp. When a voltage level of the detection end Vcs (with reference to the snubber ground level GNDsnb) is lower than a fifth predetermined voltage threshold (i.e., when a voltage level of the detection end Vcs does not exceed the predetermined voltage threshold Vth5), an ON determination result is generated, which indicates that the bypass current Idp flows through the parasitic diode Dp (i.e., which indicates that the leakage inductance current Ir rises higher than zero). As a consequence, the determination circuit 5062 will adjust the snubber control signal S2C to turn ON the snubber control switch S2, such that the snubber capacitor Cs is charged by the leakage inductance current Ir.

As shown in FIG. 6, the determination circuit 5062 is coupled to the fifth comparison circuit 5061. The determination circuit 5062 is configured to operably generate the snubber control signal S2C according to the ON determination result, such that the snubber control signal turns ON the snubber control switch when a bypass current Idp is sensed. As shown in FIG. 6, the determination circuit 5062 can include, for example but not limited to, a flip-flop FF3. An input pin D of the flip-flop FF3 receives a snubber power regulation voltage Vcc; a clock pin of the flip-flop FF3 is electrically connected to an output end of the fifth comparison circuit 5061, so that the clock pin of the flip-flop FF3 receives the ON determination result; a reset pin R of the flip-flop FF3 is electrically connected to an output end of the determination circuit 5067, so that the reset pin R of the flip-flop FF3 receives the OFF determination result; an output pin Q of the flip-flop FF3 generates the snubber control signal S2C.

The sixth comparison circuit 5063 is coupled to the current sensing resistor Rcs. The sixth comparison circuit 5063 is configured to operably generate an OFF determination result according to a voltage drop across the current sensing resistor Rcs (i.e., a voltage at a detection end Vcs) and a predetermined voltage threshold Vth6. As shown in FIG. 6, the sixth comparison circuit 5063 includes a negative input end which is electrically connected to a detection end Vcs via a resistor. The detection end Vcs for example can be electrically connected to a current sensing resistor Rcs. A positive input end of the sixth comparison circuit 5063 receives the predetermined voltage threshold Vth6.

More specifically, under a situation where the snubber control switch S2 is turned ON, when the leakage inductance current Ir drops to zero or near zero, the voltage level of the detection end Vcs (with reference to the snubber ground level GNDsnb) rises. When the voltage level of the detection end Vcs is higher than a sixth predetermined voltage threshold (i.e., when the voltage level of the detection end Vcs exceeds a predetermined voltage threshold Vth6), an OFF determination result is accordingly generated, which indicates that the leakage inductance current Ir drops to zero or near zero. As a consequence, the determination circuit 5062 will adjust the snubber control signal S2C to turn OFF the snubber control switch S2, so as to cease charging the snubber capacitor Cs via the leakage inductance current Ir. In brief, when the voltage level of the detection end Vcs exceeds the predetermined voltage threshold Vth6, it indicates that the leakage inductance current Ir is near zero or equal to zero. On the other hand, when the voltage level of the detection end Vcs does not exceed the predetermined voltage threshold Vth6, it indicates that the leakage inductance current Ir is greater than zero.

It should be understood that adopting the relative relationships between the voltage level of the detection end Vcs or Vind and the predetermined voltage thresholds to indicate information of whether the leakage inductance current Ir is greater than zero or near or equal to zero as described in the above-mentioned embodiment are given as examples, and they can be modified in many equivalent ways according to the spirit of the present invention. For example, in other embodiments, it is also practicable and within the scope of the present invention that the relative relationships between the voltage level of the detection end Vcs or Vind and the predetermined voltage thresholds can be modified to a relationship between the leakage inductance current Ir and a predetermined current threshold.

Please still refer to FIG. 6. The determination circuit 5064 can be, for example but not limited to, an AND gate logic circuit as shown in FIG. 6. Only when the level of a snubber control signal S2C and the level of an output from the sixth comparison circuit 5063 are both high level, the timer circuit 5065 is triggered to start counting a maximum ON period to generate an OFF determination result to thereby cause the snubber control signal S2C to turn OFF the snubber control switch S2.

Please still refer to FIG. 6. The timer circuit 5066 is configured to operably start counting a volt-second balance period at a time point when the snubber control switch S2 is turned ON. After the volt-second balance period ends, the timer circuit 5066 is configured to operably generate a volt-second timing signal which is inputted into the determination circuit 5067. As a result, an output signal generated from the determination circuit 5067 resets the flip-flop FF3 of the determination circuit 5062, whereby the determination circuit 5062 adjusts the snubber control signal S2C to turn OFF the snubber control switch S2.

Please still refer to FIG. 6. The determination circuit 5067 can be, for example but not limited to, a NOR gate logic circuit as shown in FIG. 6. When the determination circuit 5067 receives an UVLO determination result (which indicates that the capacitor voltage Vcb is lower than the fourth predetermined voltage threshold) or when the determination circuit 5067 receives a volt-second timing signal (which indicates that a volt-second balance has been achieved) or when the determination circuit 5067 receives an OFF determination result (which indicates that a maximum ON period has been reached) or when no bypass current Idp flow through a parasitic diode Dp, an output signal generated from the determination circuit 5067 resets the flip-flop FF3 of the determination circuit 5062, so that the determination circuit 5062 adjusts the snubber control signal S2C to turn OFF the snubber control switch S2. It should be understood that the implementation of the determination circuit 5067 as an AND gate logic circuit in the above-mentioned embodiment is only an illustrative example. In other embodiments, it is also practicable and within the scope of the present invention that the determination circuit 5067 can be any other logic circuits or determination circuits providing equivalent or similar functions.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A flyback power converter, comprising:
a transformer including:
a primary winding coupled to an input power; and
a secondary winding coupled to an output node;
a primary side switch coupled to the primary winding, the primary side switch being configured to operably switch the primary winding, so as to convert the input power, thereby causing the secondary winding to generate an output power at the output node;
a snubber capacitor, which is configured to be operably charged by a leakage inductance current of the primary winding for a snubber period which follows after a time point when the primary side switch is turned OFF; and
an active clamp snubber, which includes a snubber control switch, wherein the snubber control switch is connected in series to the snubber capacitor, and wherein the primary winding is connected in parallel to a series circuit formed by the snubber control switch and the snubber capacitor, wherein the leakage inductance current charges the snubber capacitor through the snubber control switch during the snubber period;
wherein a capacitor voltage across the snubber capacitor provides an electrical power to the active clamp snubber, and wherein a voltage level of a reference node between the snubber control switch and the snubber capacitor serves as a snubber ground level of the active clamp snubber.

2. The flyback power converter of claim 1, wherein the active clamp snubber further includes:
a power regulation circuit, which is configured to operably convert the capacitor voltage to a snubber power regulation voltage which is supplied to the active clamp snubber as the electrical power; and
a control signal generation circuit coupled to the power regulation circuit and the snubber control switch, the control signal generation circuit being configured to operably sense a time point when the primary side switch is turned from ON to OFF, and to operably generate a snubber control signal for turning ON the snubber control switch.

3. The flyback power converter of claim 1, wherein the active clamp snubber further includes:
an overcharging protection circuit including a first comparison circuit, wherein the first comparison circuit is configured to operably generate an overcharging comparison signal when the capacitor voltage exceeds a first predetermined voltage threshold, so as to electrically connect the snubber capacitor to a bleeder current path in the overcharging protection circuit, so that the capacitor voltage is controlled not exceeding the first predetermined voltage threshold.

4. The flyback power converter of claim 2, wherein the active clamp snubber further includes:
a bypass diode, which is connected in parallel to the snubber control switch;
wherein the control signal generation circuit is configured to operably sense a bypass current flowing through the bypass diode, so as to confirm the time point when the primary side switch is turned from ON to OFF, for turning ON the snubber control switch to charge the snubber capacitor by the leakage inductance current.

5. The flyback power converter of claim 4, wherein the control signal generation circuit includes:
a second comparison circuit coupled to the bypass diode, wherein the second comparison circuit is configured to operably generate an ON determination result when a voltage level of a detection end of the bypass diode does not exceed a second predetermined voltage threshold, the ON determination result indicating that the bypass current is flowing through the bypass diode; and
a first determination circuit coupled to the second comparison circuit, wherein the first determination circuit is configured to operably generate the snubber control signal according to the ON determination result for turning ON the snubber control switch when the bypass current is sensed.

6. The flyback power converter of claim 5, wherein the control signal generation circuit further includes:
a third comparison circuit coupled to the bypass diode, wherein the third comparison circuit is configured to operably generate an OFF determination result when the voltage level of the detection end of the bypass diode exceeds a third predetermined voltage threshold, wherein the generated OFF determination result is inputted to the first determination circuit, wherein the first determination circuit is configured to operably generate the snubber control signal according to the OFF determination result for turning OFF the snubber control switch.

7. The flyback power converter of claim 5, wherein the control signal generation circuit further includes:
a fourth comparison circuit, which is configured to operably generate an under voltage lockout (UVLO) determination result when the capacitor voltage is lower than a fourth predetermined voltage threshold, wherein the first determination circuit is configured to operably generate the snubber control signal according to the UVLO determination result for turning OFF the snubber control switch.

8. The flyback power converter of claim 7, wherein the control signal generation circuit further includes:
a first timer circuit, which is configured to operably start counting a volt-second balance period at a time point when the snubber control switch is turned ON, wherein after the volt-second balance period ends, the first timer circuit is configured to operably generate a volt-second timing signal; and
a second determination circuit, which is configured to operably cause the first determination circuit to turn OFF the snubber control switch according to the volt-second timing signal after the volt-second balance period ends.

9. The flyback power converter of claim 1, wherein the active clamp snubber further includes:
a second timer circuit, which is configured to operably start counting a maximum ON period at a time point when the snubber control switch is turned ON, whereby the snubber control switch is turned OFF after the maximum ON period ends.

10. The flyback power converter of claim 3, wherein the overcharging protection circuit further includes:
an overcharging switch, which is configured to operably electrically connect the snubber capacitor to the bleeder current path in the overcharging protection circuit according to the overcharging comparison signal when the capacitor voltage exceeds the first predetermined voltage threshold; and
an overcharging current source coupled to the snubber capacitor and the overcharging switch, wherein the overcharging current source is configured to operably generate a bleeder current on the bleeder current path, so as to control the capacitor voltage not exceeding the first predetermined voltage threshold.

11. The flyback power converter of claim 3, wherein, with reference to the snubber ground level, the first predetermined voltage threshold is correlated with a product of an output voltage of the output power multiplied by a turn ratio of the primary winding to the secondary winding.

12. The flyback power converter of claim 2, wherein the active clamp snubber further includes:
a current sensing circuit having a current sensing transistor and a current sensing resistor, wherein the current sensing transistor is connected in series to the current sensing resistor, and wherein the snubber control switch is connected in parallel to a series circuit formed by the current sensing transistor and the current sensing resistor;
wherein the control signal generation circuit includes:
a fifth comparison circuit coupled to the current sensing resistor, wherein the fifth comparison circuit is configured to operably generate an ON determination result according to a voltage drop across the current sensing resistor and a fifth predetermined voltage threshold; and
a third determination circuit coupled to the fifth comparison circuit, wherein the third determination circuit is configured to operably generate the snubber control signal according to the ON determination result for turning the snubber control signal turns ON the snubber control switch.

13. The flyback power converter of claim 12, wherein the control signal generation circuit further includes:
a sixth comparison circuit coupled to the current sensing resistor, wherein the sixth comparison circuit is configured to operably generate an OFF determination result according to the voltage drop across the current sensing resistor and a sixth predetermined voltage threshold;
wherein the third determination circuit is further configured to operably generate the snubber control signal according to the OFF determination result for turning OFF the snubber control switch.

14. The flyback power converter of claim 13, wherein the control signal generation circuit further includes:
a third timer circuit, which is configured to operably start counting a maximum ON period at a time point when the snubber control switch is turned ON, whereby the snubber control switch is turned OFF after the maximum ON period ends, and the third timer circuit ceases counting according to the OFF determination result.

15. The flyback power converter of claim 13, wherein the control signal generation circuit further includes:
a fourth timer circuit, which is configured to operably start counting a volt-second balance period at a time point when the snubber control switch is turned ON, so that the snubber control switch is turned OFF after the volt-second balance period ends.

16. An active clamp snubber, which is configured to operably control a leakage inductance current of a primary winding of a flyback power converter to charge a snubber capacitor for a snubber period which follows after a time point when the primary side switch is turned OFF; the active clamp snubber comprising:
a snubber control switch, which is connected in series to the snubber capacitor, and wherein the primary winding is connected in parallel to a series circuit formed by the snubber control switch and the snubber capacitor, wherein the leakage inductance current charges the snubber capacitor through the snubber control switch during the snubber period;
a power regulation circuit, which is configured to operably convert the capacitor voltage to a snubber power regulation voltage, wherein the snubber power regulation voltage is configured to operably supply an electrical power to the active clamp snubber; and
a control signal generation circuit coupled to the power regulation circuit and the snubber control switch, the control signal generation circuit being configured to operably sense a time point when the primary side switch is turned from ON to OFF, and accordingly to operably generate a snubber control signal for turning ON the snubber control switch;
wherein a voltage level of a reference node between the snubber control switch and the snubber capacitor is configured to operably function as a snubber ground level of the active clamp snubber.

17. The active clamp snubber of claim 16, further comprising:
an overcharging protection circuit including a first comparison circuit, wherein the first comparison circuit is configured to operably generate an overcharging comparison signal when the capacitor voltage exceeds a first predetermined voltage threshold, so as to electrically connect the snubber capacitor to a bleeder current path in the overcharging protection circuit, so that the capacitor voltage is controlled not exceeding the first predetermined voltage threshold.

18. The active clamp snubber of claim 16, further comprising:
a bypass diode, which is connected in parallel to the snubber control switch;
wherein the control signal generation circuit is configured to operably sense a bypass current flowing through the bypass diode, so as to confirm the time point when the primary side switch is turned from ON to OFF, for turning ON the snubber control switch to charge the snubber capacitor by the leakage inductance current.

19. The active clamp snubber of claim 18, wherein the control signal generation circuit includes:
a second comparison circuit coupled to the bypass diode, wherein the second comparison circuit is configured to operably generate an ON determination result when a voltage level of a detection end of the bypass diode does not exceed a second predetermined voltage threshold, the ON determination result indicating that the bypass current is flowing through the bypass diode; and
a first determination circuit coupled to the second comparison circuit, wherein the first determination circuit is configured to operably generate the snubber control signal according to the ON determination result for turning ON the snubber control switch when the bypass current is sensed.

20. The active clamp snubber of claim 19, wherein the control signal generation circuit further includes:
a third comparison circuit coupled to the bypass diode, wherein the third comparison circuit is configured to operably generate an OFF determination result when the voltage level of the detection end of the bypass diode exceeds a third predetermined voltage threshold, wherein the generated OFF determination result is inputted to the first determination circuit, wherein the first determination circuit is configured to operably generate the snubber control signal according to the OFF determination result for turning OFF the snubber control switch.

21. The active clamp snubber of claim 19, wherein the control signal generation circuit further includes:
a fourth comparison circuit, which is configured to operably generate an under voltage lockout (UVLO) determination result when the capacitor voltage is lower than a fourth predetermined voltage threshold, wherein the first determination circuit is configured to operably generate the snubber control signal according to the UVLO determination result for turning OFF the snubber control switch.

22. The active clamp snubber of claim 21, wherein the control signal generation circuit further includes:
a first timer circuit, which is configured to operably start counting a volt-second balance period at a time point when the snubber control switch is turned ON, wherein after the volt-second balance period ends, the first timer circuit is configured to operably generate a volt-second timing signal; and
a second determination circuit, which is configured to operably cause the first determination circuit to turn OFF the snubber control switch according to the volt-second timing signal after the volt-second balance period ends.

23. The active clamp snubber of claim 16, further comprising:
a second timer circuit, which is configured to operably start counting a maximum ON period at a time point when the snubber control switch is turned ON, whereby the snubber control switch is turned OFF after the maximum ON period ends.

24. The active clamp snubber of claim 17, wherein the overcharging protection circuit further includes:
an overcharging switch, which is configured to operably electrically connect the snubber capacitor to the bleeder current path in the overcharging protection circuit according to the overcharging comparison signal when the capacitor voltage exceeds the first predetermined voltage threshold; and
an overcharging current source coupled to the snubber capacitor and the overcharging switch, wherein the overcharging current source is configured to operably generate a bleeder current on the bleeder current path, so as to control the capacitor voltage not exceeding the first predetermined voltage threshold.

25. The active clamp snubber of claim 17, wherein, with reference to the snubber ground level, the first predetermined voltage threshold is correlated with a product of an output voltage of the output power multiplied by a turn ratio of the primary winding to the secondary winding.

26. The active clamp snubber of claim 16, further comprising:
a current sensing circuit having a current sensing transistor and a current sensing resistor, wherein the current sensing transistor is connected in series to the current sensing resistor, and wherein the snubber control switch is connected in parallel to a series circuit formed by the current sensing transistor and the current sensing resistor;
wherein the control signal generation circuit includes:
a fifth comparison circuit coupled to the current sensing resistor, wherein the fifth comparison circuit is configured to operably generate an ON determination result according to a voltage drop across the current sensing resistor and a fifth predetermined voltage threshold; and
a third determination circuit coupled to the fifth comparison circuit, wherein the third determination circuit is configured to operably generate the snubber control signal according to the ON determination result for turning ON the snubber control switch.

27. The active clamp snubber of claim 26, wherein the control signal generation circuit further includes:
a sixth comparison circuit coupled to the current sensing resistor, wherein the sixth comparison circuit is configured to operably generate an OFF determination result according to the voltage drop across the current sensing resistor and a sixth predetermined voltage threshold;
wherein the third determination circuit is further configured to operably generate the snubber control signal according to the OFF determination result for turning OFF the snubber control switch.

28. The active clamp snubber of claim 27, wherein the control signal generation circuit further includes:
a third timer circuit, which is configured to operably start counting a maximum ON period at a time point when the snubber control switch is turned ON, whereby the snubber control switch is turned OFF after the maximum ON period ends, and the third timer circuit ceases counting according to the OFF determination result.

29. The active clamp snubber of claim 27, wherein the control signal generation circuit further includes:
a fourth timer circuit, which is configured to operably start counting a volt-second balance period at a time point when the snubber control switch is turned ON, so that the snubber control switch is turned OFF after the volt-second balance period ends.

30. An overcharging protection circuit, which is configured to operably control an active clamp snubber, wherein the active clamp snubber is configured to operably control a leakage inductance current of a primary winding of a flyback power converter to charge a snubber capacitor for a snubber period which follows after a time point when the primary side switch is turned OFF; the active clamp snubber including: a snubber control switch, which is connected in series to the snubber capacitor, and wherein the primary winding is connected in parallel to a series circuit formed by the snubber control switch and the snubber capacitor, wherein the leakage inductance current charges the snubber capacitor through the snubber control switch during the snubber period; a power regulation circuit, which is configured to operably convert the capacitor voltage to a snubber power regulation voltage, wherein the snubber power regulation voltage is configured to operably supply an electrical power to the active clamp snubber; and a control signal generation circuit coupled to the power regulation circuit and the snubber control switch, the control signal generation circuit being configured to operably sense a time point when the primary side switch is turned from ON to OFF, and accordingly to operably generate a snubber control signal for turning ON the snubber control switch; wherein a voltage level of a reference node between the snubber control switch and the snubber capacitor serves as a snubber ground level of the active clamp snubber; wherein the overcharging protection circuit comprises:
a bleeder current path coupled to the snubber capacitor; and
a first comparison circuit, which is configured to operably generate an overcharging comparison signal when the capacitor voltage exceeds a first predetermined voltage threshold, so as to electrically connect the snubber capacitor to the bleeder current path, so that a bleeder current is generated from the snubber capacitor, whereby the capacitor voltage is control not exceeding the first predetermined voltage threshold.

31. The overcharging protection circuit of claim 30, further comprising:
an overcharging switch, which is configured to operably electrically connect the snubber capacitor to the bleeder current path in the overcharging protection circuit according to the overcharging comparison signal when the capacitor voltage exceeds the first predetermined voltage threshold; and
an overcharging current source coupled to the snubber capacitor and the overcharging switch, wherein the overcharging current source is configured to operably generate the bleeder current on the bleeder current path, so as to control the capacitor voltage not exceeding the first predetermined voltage threshold;
wherein the overcharging switch and the overcharging current source form the bleeder current path.
